(19) United States
(12) Patent Application Publication
(10) Pub. No.: US 2026/0298027 A1
(43) Pub. Date: Oct. 1, 2026

(54) Auxiliary Step Apparatus

(71) Applicant: Anthony Scott Wadie, Macomb, MI (US)

(72) Inventor: Anthony Scott Wadie, Macomb, MI (US)

(21) Appl. No.: 19/095,590

(22) Filed: Mar. 31, 2025

(51) Int. Cl. E06C 7/16; E06C 1/00; E06C 7/08

(52) U.S. Cl. CPC E06C 7/165; E06C 1/005; E06C 7/081

(57) ABSTRACT

An auxiliary step apparatus which is detachably secured to a structurally sound horizontal member, particularly a bunk bed ladder, by means of an adjustable clamping mechanism that does not mar, scratch, dent or otherwise damage the horizontal member and which provides the horizontal member with a surface area greater than that of the horizontal member. The auxiliary step apparatus can be installed onto the rung of a bunk bed ladder to provide a significantly increased surface area than that of the bunk bed rung. The auxiliary step apparatus comprises a base member, a top cushioned layer adhered to the base member and a clamping mechanism for simple and secure installation to a horizontal member and particularly to a rung of a bunk bed ladder.

### FIELD OF INVENTION

The present invention relates to an auxiliary step apparatus for accessing an upper bunk bed. More particularly, the present invention relates to an auxiliary step apparatus which can be installed on the rung of a bunk bed ladder or any type of horizontal beam of varying dimensions, comprising an adjustable clamping mechanism and a tread having a greater surface area than a conventional ladder rung.

### BACKGROUND OF THE INVENTION

While bunk beds often are associated for use by children, many bunk bed designs cater specifically to adults, featuring sturdier construction and higher weight limits. Bunk beds are a versatile space-saving solutions applicable to a variety of living situations, including small apartments, shared residences, guest accommodations, and dormitories. Designed with varying weight capacities and construction, bunk beds cater to diverse needs. For example, in college dorms, bunk beds commonly are used to maximize floor space for essential furniture such as dressers and desks. However, a potential drawback with bunk beds, regardless of a user's age, is the ladder access to the upper bunk. The standard narrow rungs or steps can cause discomfort, and the limited surface area on each ladder rung step increase the risk of slipping or tripping, and falling from the ladder.

### PRIOR ART

The prior art is replete with variations on the standard bunk bed ladder. For example, U.S. Pat. No. 10,849,434 B1 to Gonzalez is directed to a fold-down stairs for a bunk bed. U.S. Pat. No. 5,003,650 to Caya relates to a bunk bed ladder which is secured to the upper and lower rails of two bunk beds. U.S. Pat. No. 4,193,146 to Fredman et al. discloses a bracket for mounting a bunk bed ladder from the bed rail of the upper bunk to prevent the ladder from shifting along the bed rail. None of these prior art references contemplate the widening of the ladder rungs.

U.S. Pat. No. 4,241,807 to McKenna et al. discloses a step attachment to a conventional ladder, the attachment having two widened horizontal steps in parallel, spaced-apart relation over the other, the two steps connected by two vertical supports that are attachable to a conventional ladder. While McKenna et al. provides a step attachment device to provide two widened horizontal steps, it is a one-piece device which appears to hang onto and over the ladder rungs, rather than being separate wider steps which are secured to the ladder rungs. U.S. Pat. No. 4,804,063 to Faris discloses an auxiliary safety step for a ladder having fluted round rungs wherein each step has an arcuate underside which is adapted to install onto fluted round rung and secured by set screws and auxiliary support bars. While Faris does disclose providing a tread having a width greater than a ladder rung, the treads are configured for use with only one type of ladder rung. In addition, the securement method in Faris mars the rung with the set screws and auxiliary support bars.

Despite the various attempts in the prior art, there is a continuing deficiency in the field of bunk bed ladder design, specifically regarding user safety and comfort. Thus, a need still exists for an auxiliary step apparatus which can be removably secured to a ladder rung or a horizontal beam member. Such an auxiliary step apparatus should be engineered to achieve a secure attachment without causing marring, scratching, denting or other forms of damage to the ladder rung, the ladder structure, or to the horizontal beam surface to which it is secured. Also, such an auxiliary step should provide a tread having a greater surface area than the ladder rung or horizontal beam member to which it is being removably secured. In addition, such an auxiliary step should enhance the stability and mitigate the risk of slippage or accidental falls. And, such an auxiliary step should prioritize ergonomic considerations, ensuring a level of user comfort that demonstrably exceeds that provided by a conventional rung of a bunk bed ladder.

### SUMMARY OF THE INVENTION

The present subject matter relates to an auxiliary step apparatus which is engineered for heavy-duty application in various settings, including, for example, space-saving bunk bed ladder steps used in shared living environments and educational institutions. The auxiliary step apparatus offers enhanced safety and increased comfort, such as with frequently used bunk bed ladders. The auxiliary step apparatus can be customized to a personalized aesthetic of the user's living space and offers a tread having a greater surface area than a standard bunk bed ladder rung. The auxiliary step apparatus of the present subject matter is engineered for simple and secure installation by means of a clamping mechanism, ensuring stability and ease of use.

Accordingly, it is an object of the present subject matter to provide at least one auxiliary step apparatus which can be installed on a rung of a bunk bed ladder.

It is another object of the present subject matter to provide a plurality of auxiliary step apparatus for installation on the several rungs of a bunk bed ladder, each auxiliary step apparatus providing a durable, non-slip step for easy access and which have wider treads compared to standard rungs, thereby offering a plurality of steps each with a greater surface area than the conventional ladder rungs.

It is still another object of the present subject matter to provide an auxiliary step apparatus having a simple and easy installation process, thereby ensuring that a plurality of auxiliary step apparatus can be installed on the rungs of a bunk bed ladder with minimal effort.

It is a yet another object of the present subject matter to provide an auxiliary step apparatus having a cushioned top surface that is durable, safe, and stylish.

It is a further object of the present subject matter to provide an auxiliary step apparatus that can be customized for rungs or horizontal beams of various lengths.

It is still a further object of the present subject matter to provide an auxiliary step apparatus which utilizes a clamping mechanism in the form of a set of heavy-duty C-clamps made from high quality steel, such as powder coated mild steel or stainless steel, through precision casting, ensuring stability and strength, the C-clamps being rustproof, wear-resistant, and corrosion-resistant, thereby providing durability and reliability.

It is an additional object of the present subject matter to provide an auxiliary step apparatus utilizing a set of C-clamps having a clamping range of from about 0.2″ to about 1.0 inch and a throat depth of about 1.0 inch, such mini screw clamps capable of handling high pressure without deforming or breaking, thereby providing a superior user experience.

It is an additional object of the present subject matter to provide an auxiliary step apparatus comprising a base member composed of durable wood, such as pine.

It is still an additional object of the present subject matter to provide an auxiliary step apparatus comprising a base member composed of an extruded, durable, and low maintenance plastic material, such as uPVC (unplasticized polyvinyl chloride).

It is yet another object of the present subject matter to provide an auxiliary step apparatus having a cushioned top layer, such as a high-density NBR foam cotton layer adhered to a base member, thereby providing the user with added comfort, and eliminating the use of uncomfortable narrow wood rungs.

These and other objects of the present subject matter are accomplished by providing a plurality of auxiliary step apparatus, each auxiliary step having a wider tread and a greater surface area than a standard bunk bed rung, each auxiliary step being engineered to install over a rung and be removably secured thereto by a clamping mechanism. To ensure additional comfort, a cushioned material is adhered to the top surface of each auxiliary step.

### BRIEF DESCRIPTION OF DRAWINGS

FIG. 1 is a side perspective view of an auxiliary step apparatus of the present invention installed on the rung of a bunk bed ladder.

FIG. 2 is a bottom perspective view of the auxiliary step apparatus showing the underside of base member of the first embodiment of the present subject matter.

FIG. 3 is a side bottom view of the auxiliary step apparatus of the present subject matter depicting the clamping mechanism.

FIG. 4 is a side perspective view of a bunk bed ladder having an auxiliary step apparatus of the present subject matter installed onto each of the five rungs of the bunk bed ladder.

FIG. 5 is a top perspective view of a second embodiment of the auxiliary step apparatus of the present subject matter.

FIG. 6 is a bottom perspective view of the second embodiment of the auxiliary step apparatus of the present subject matter showing the underside of the base member and the clamping mechanism.

FIG. 7 is a side perspective view of a second embodiment of the auxiliary step apparatus of the present subject matter showing the clamping mechanism slidingly secured within the base member.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The terms “step”, “steps”, “auxiliary step”, “auxiliary steps”, “bunk bed steps”, “bunk steps” derivates thereof, and similar terms may be used throughout the specification and it is to be understood that such terms are interchangeable and all refer to the auxiliary step apparatus of the present subject matter. In addition, the terms “tread” and “treads” may be used throughout the specification and it is to be understood that such terms refer to the surface of a step.

Also, it is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

The present subject matter is directed an auxiliary step apparatus which is detachably secured to a structurally sound horizontal member, such as a horizontal beam, a horizontal bar on a boat ladder, a deck railing, the side wall of a boat, and a rung of a ladder, particularly a bunk bed ladder, by means of an adjustable clamping mechanism that does not mar, scratch, dent or otherwise damage the horizontal member and which provides the horizontal member with a surface area greater than that of the horizontal member. For example, an auxiliary step apparatus installed onto the rung of a bunk bed ladder provides a significantly increased surface area than that of the bunk bed rung. The auxiliary step apparatus comprises a base member, a top cushioned layer adhered to the base member and a clamping mechanism for simple and secure installation to a horizontal member and particularly to a rung of a bunk bed ladder.

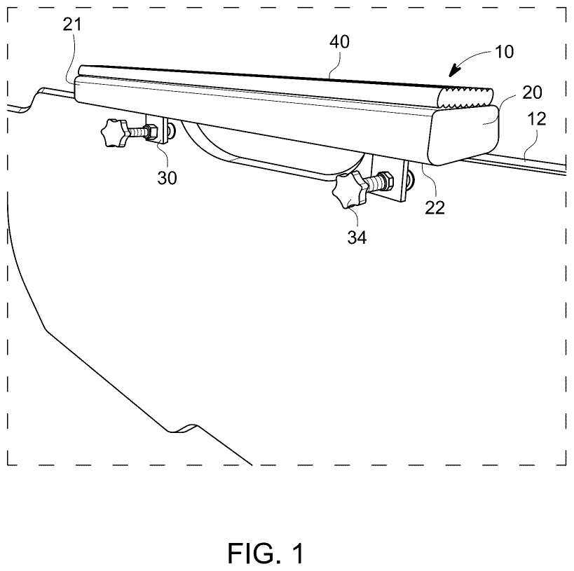

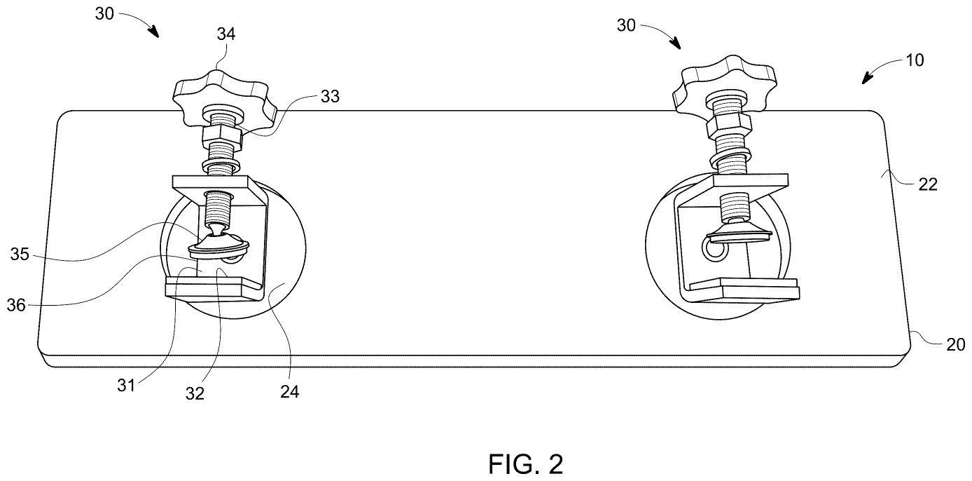

FIG. 1 illustrates the auxiliary step apparatus 10 of the present subject matter detachably secured to the rung 12 of a bunk bed ladder, the auxiliary step 10 comprising a base member 20 having an upper surface 21, an under surface 22, an adjustable clamping mechanism 30 affixed to the under surface 22 and a top cushion layer 40 which is adhered to the upper surface 21 of the base member. Referring now to FIG. 2, the under surface 22 of the base member 20 comprises two recessed areas 24 within each of which a C-clamp frame element 31 of the adjustable clamping mechanism 30 is disposed and secured by any suitable means, such as by use of a threaded screw.

The base member 20 may be composed of any durable wood material, suitable examples of which are well known in the prior art. Preferably pine wood is used as the base member.

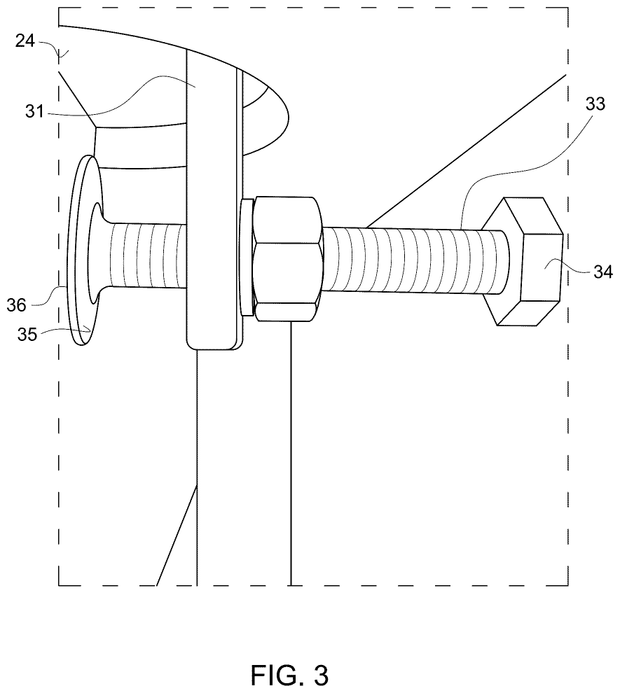

As shown in FIG. 2 and FIG. 3, the adjustable clamping mechanism 30 is in the form of a traditional C-clamp comprising a frame element 31 with a clamping end 32 having a padded material 36, a threaded rod 33 having a threaded handle or knob 34 secured at a proximal first end and a swivel shoe 35 affixed to the distal second end, the swivel shoe also being provided with a padded material 36. Any material which will prevent the clamp from marring, scratching, denting, or otherwise damaging the ladder rung is suitable for use as the padded material, examples of which include felt, foam or rubber. Preferably, the padding is in the form of a rubberized material, such as a rubberized felt material. The adjustable clamping mechanism 30 allows the auxiliary step apparatus of the present subject matter to be installed on horizontal members having various widths. In this manner, the auxiliary step apparatus can be installed on the rung of a bunk bed ladder regardless of the length and width of the rung, thereby ensuring compatibility with different bunk bed ladder dimensions.

The clamping mechanism is composed of a high-quality steel, such as a powder coated mild steel or stainless steel. In one embodiment, the high-quality steel is 304 stainless steel. The steel component should be rustproof, wear-resistant, and corrosion-resistant, to provide durability and continuous reliability. The C-clamp mechanism has a clamping range of from about 0.2″ to about 1.0 inch and a throat depth of about 1.0 inch, sufficient to manage high pressure without deforming or breaking.

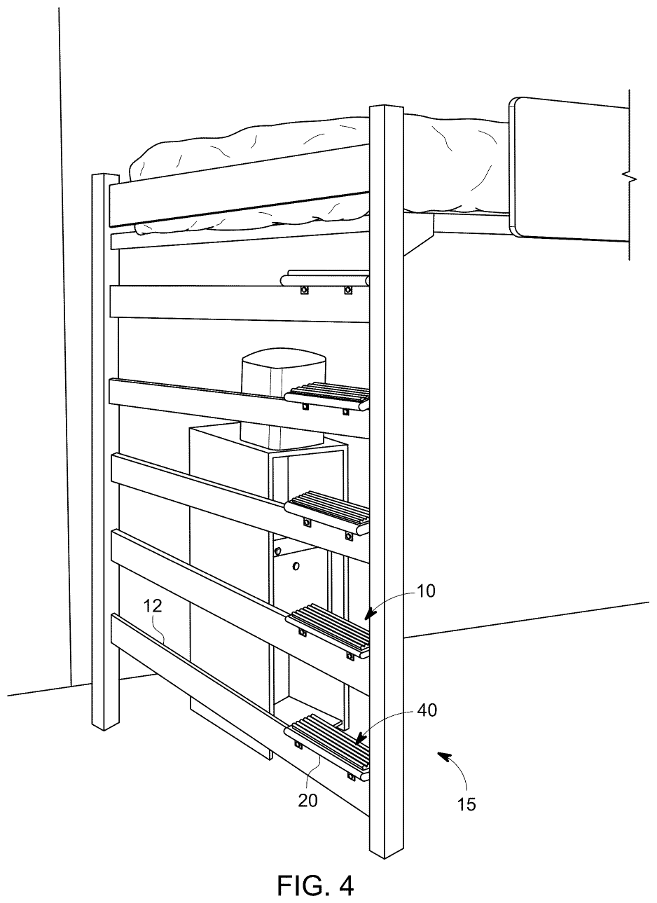

Referring now to FIG. 4, a bunk bed ladder 15 is shown having a plurality of rungs 12, each rung having an auxiliary step apparatus 10 installed onto the rung and detachably secured thereto by the adjustable clamping mechanism 30.

The top cushion layer 40 is affixed to the upper surface 21 of the step 10 by any suitable adhesive means as will be obvious to those skilled in the art. The addition of the top cushion layer provides added comfort and reduces the risk of slipping or tripping. The material of the top cushion layer can be composed of any material which is capable of being customized with different colors, patterns and finishing options. Preferably the top cushion layer is composed of a rubberized foam material. More preferably, the top cushion layer is composed of a NBR (nitrile butadiene rubber). Most preferably, the NBR top cushion layer has a contoured or corrugated surface.

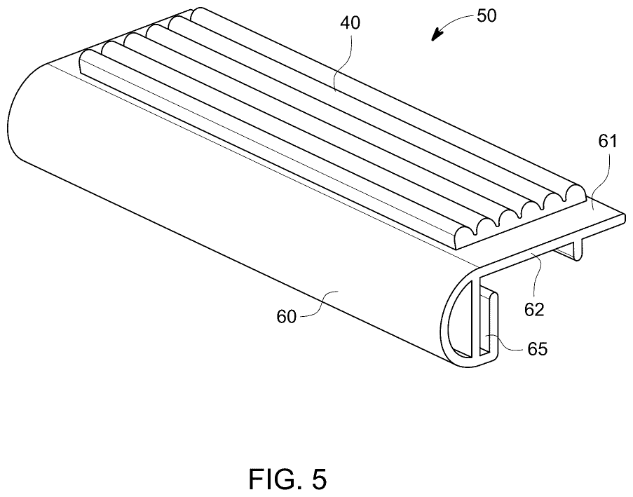

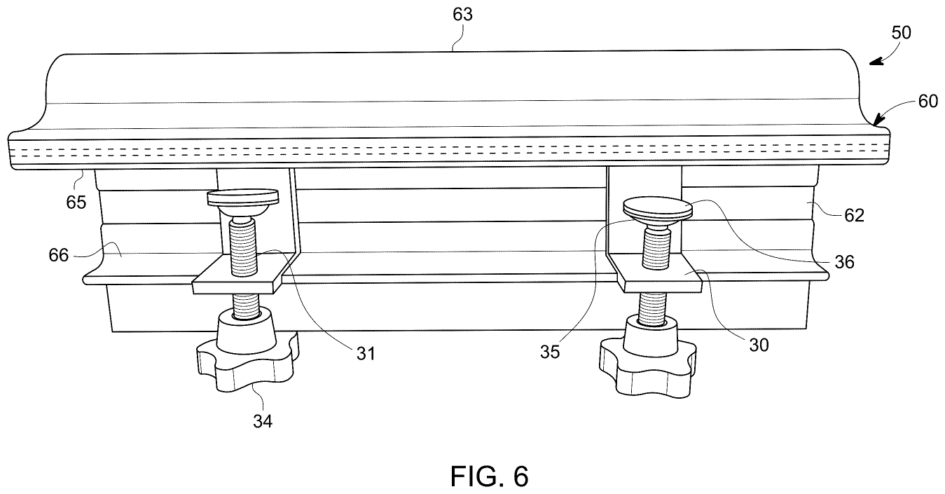

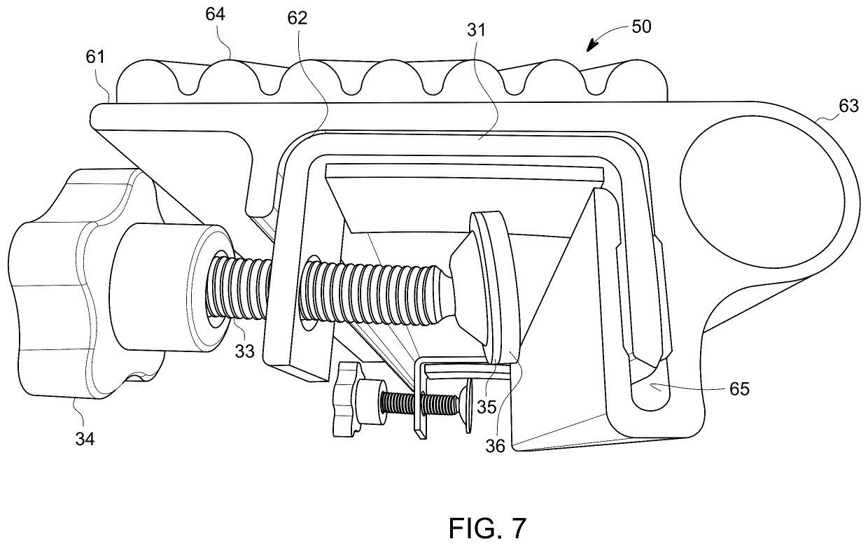

A second embodiment of the auxiliary step apparatus of the present subject matter is shown in FIG. 5, FIG. 6, and FIG. 7. In this embodiment, the base member 60 of the auxiliary step apparatus is composed of an extruded, durable, low maintenance plastic material. In a preferred embodiment, the base member 60 is formed as a one-piece extrusion composed of uPVC (unplasticized polyvinyl chloride). Base member 60 comprises an upper surface 61 and an under surface 62, a bullnose front surface 63, a top cushion layer 40 adhered to the upper surface 61, and the adjustable clamping mechanism 30 as shown in FIG. 6 and FIG. 7. The adjustable clamping mechanism is a secured to the under surface 62 of the base member 60.

Referring now to FIG. 6 and FIG. 7 the under surface 62 of the base member 60 comprises clamp channel 65 and web gusset 66 which are engineered to retain the clamp mechanism. More specifically, the C-clamp frame element 31 is retained within the clamp channel 65 and web gusset 66 in such a manner that is the frame element 31 of the C-Clamp can be slidingly guided along the channel and web gusset, thereby providing adjustability of the clamping mechanism depending upon the length of the horizontal member on which it is installed.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S. C § 112, sixth paragraph, unless the element is expressly recited using the phrase “means for . . . ” and no method or process step herein is to be construed under those provisions unless the step, or steps, are expressly recited using the phrase “step(s) for. . . .”

1. An auxiliary step apparatus to be detachably secured to a structurally sound horizontal member, said auxiliary step apparatus comprising a base member having an upper surface and an under surface, an adjustable clamping mechanism integrated within said under surface of said base member, a top cushion layer affixed to said upper surface, wherein when said auxiliary step apparatus is detachably secured onto said horizontal member, the resulting surface area of said horizontal member is increased.

2. The auxiliary step apparatus in accordance with claim 1, wherein said clamping mechanism is in the form of a set of adjustable C-clamps, each of said C-clamps comprising a frame element with a clamping end having a padded material secured thereto, a threaded rod having a proximal end and a distal end, a threaded knob secured to said proximal end and a swivel shoe secured to said distal end, said swivel shoe having a padded material secured thereto.

3. The auxiliary step apparatus in accordance with claim 2, wherein said auxiliary step apparatus is installed onto and detachably secured to said horizontal member with said set of adjustable C-clamps in such a manner that said padded material of said clamping end and said padded material of said swivel shoe are in contact with opposing sides of said horizontal member.

4. The auxiliary step apparatus in accordance with claim 3, wherein said padded material is composed of rubberized felt material.

5. The auxiliary step apparatus in accordance with claim 1, wherein said top cushion layer is composed of a foam material which can be customized with different colors, patterns, and finishes.

6. The auxiliary step apparatus in accordance with claim 2, wherein said top cushion layer has a contoured surface.

7. The auxiliary step apparatus in accordance with claim 6, wherein said top cushion layer is composed of rubberized foam material.

8. The auxiliary step apparatus in accordance with claim 7, wherein said rubberized foam material is nitrile butadiene rubber (NBR).

9. The auxiliary step apparatus in accordance with claim 2, wherein said base member is composed of a durable wood material and wherein said under surface of said base member comprises a recessed area within which said frame element of one of said C-clamps is disposed and affixed therein.

10. The auxiliary step apparatus in accordance with claim 9, wherein said under surface of said base member comprises a recessed area for each of said set of C-clamps.

11. The auxiliary step apparatus in accordance with claim 2, wherein said base member is composed of an extrudable durable plastic material.

12. The auxiliary step apparatus in accordance with claim 11, wherein said base member is formed as a one-piece extrusion composed of unplasticized polyvinyl chloride (uPVC).

13. The auxiliary step apparatus in accordance with claim 12, said under surface of said base member comprising a clamp channel and a web gusset which are engineered to retain said set of adjustable C-clamps in such a manner that said C-clamps can be slidably guided along said clamp channel and said web gusset.

14. The auxiliary step apparatus in accordance with claim 1, wherein said horizontal member is a rung of a bunk bed ladder.

15. An auxiliary step apparatus to be detachably secured to a rung of a bunk bed ladder, said auxiliary step apparatus comprising a base member having an upper surface and an under surface, an adjustable clamping mechanism integrated within said under surface of said base member, a top cushion layer affixed to said upper surface, wherein when said auxiliary step apparatus is detachably secured onto said rung, the resulting surface area of said rung is increased.

16. The auxiliary step apparatus in accordance with claim 15, wherein said clamping mechanism is in the form of a set of adjustable C-clamps, each of said C-clamps comprising a frame element with a clamping end having a padded material secured thereto, a threaded rod having a proximal end and a distal end, a threaded knob secured to said proximal end and a swivel shoe secured to said distal end, said swivel shoe having a padded material secured thereto.

17. The auxiliary step apparatus in accordance with claim 16, wherein said base member is composed of a durable wood material and wherein said under surface of said base member comprises a recessed area within which said frame element of one of said C-clamps is disposed and affixed therein.

18. The auxiliary step apparatus in accordance with claim 15, wherein said base member is formed as a one-piece extrusion composed of unplasticized polyvinyl chloride (uPVC).

19. The auxiliary step apparatus in accordance with claim 18, said under surface of said base member comprising a clamp channel and a web gusset which are engineered to retain said set of adjustable C-clamps in such a manner that said C-clamps can be slidably guided along said clamp channel and said web gusset.

20. The auxiliary step apparatus in accordance with claim 15, wherein said top cushion layer is composed of rubberized foam material.
